(19) United States
(12) Patent Application Publication
(10) Pub. No.: US 2005/0076198 A1
(43) Pub. Date: Apr. 7, 2005

(54) Authentication system

(75) Inventors: Stewart A. Skomra, Poway, CA (US); Frank D. Ciotti JR., The Woodlands, TX (US)

Correspondence Address: TIMOTHY P. O'HAGAN, 8710 KILKENNY CT, FORT MYERS, FL, 33912, US

(73) Assignee: Apacheta Corporation, San Francisco, CA (US)

(21) Appl. No.: 10/755,974

(22) Filed: Jan. 12, 2004

Related U.S. Application Data
(60) Provisional application No. 60/508,252, filed on Oct. 2, 2003.

(51) Int. Cl. H04L 9/00

(52) U.S. Cl. 713/156

(57) ABSTRACT

A method of providing a digital certificate authenticating the identity of a user of an endpoint device and over an open network is provided. The method comprises establishing a secure connection with the endpoint device. A digital certificate request is received from the endpoint device over the secure connection. The digital certificate request comprises an indication of the identity of the user of the endpoint device and a public encryption key. A validation parameter associated with the user is obtained from a trusted database. Instructions to provide verification data are sent to the endpoint device and verification data is received back from the endpoint device and validated. A signed digital certificate is provided to the endpoint device over the secure connection only if the verification data correlates to the validation parameter.

### TECHNICAL FIELD

The present invention relates to authentication of an endpoint device in an open network environment and more specifically to an authentication process for provisioning an entity with a digitally signed client certificate in a public key infrastructure.

### BACKGROUND OF THE INVENTION

Recent advances in wireless network technology have made it possible and cost effective to deploy wireless network infrastructures in both private and public facilities. These wireless networks provide Internet connectivity to client devices such as lap top computers, PDA's, and other wireless client systems that are within range of the wireless network.

In a wireless network, frames are transferred by modulating a radio frequency signal to transmit the frame. This creates security issues that are not present in wired network. In a wired network, potential receipt of a frame is limited only to those devices that are physically coupled (or inductively coupled) to the transmission medium. A combination of firewalls, routers, and limiting physical access to the wired network provides some security to information transmitted on such a network. However, in a wireless network, the RF signals can be received, and the frame potentially recovered, by any device, at any physical location, so long as the device is capable of detecting and demodulating the modulated RF signal. This opens the potential for an unscrupulous user to receive information properly transmitted between legitimate network devices (e.g. eves drop) or to emulate a legitimate network device for accessing services provided by network servers (e.g. masquerading).

Eavesdropping is readily resolved by utilizing encryption (e.g. secure sockets layer, VPN, etc) for the exchange of data between devices on the network. For example, if servers that accept connections from devices over the network require secure sockets layer (SSL), the information can not be readily decrypted by any device other than the device establishing the SSL connection and the server. However, SSL communications alone do not necessarily provide secure communication channels. If digital certificates are not used, a non-authorized endpoint device can readily establish an SSL connection to the server and obtain any of the services provided by such server.

One known attempt to prevent access to network services by unauthorized devices is to provide proof of knowledge of a secret key. For example, the IEEE 802.11 standard provides a protocol known as Wired Equivalent Privacy (WEP). For this system to work, the secret key (or WEP key) must be manually entered into each access point and the 802.11 client software of each device. Assuming the secret key is long enough to effectively prevent trial and error detection (e.g. dictionary or brute force attacks), no device can eaves drop or communicate on the wireless network without first obtaining the secret key. However, this secret key solution fails to resolve security issues for at least two reasons. First, distributing a secret key to every device that is permitted to operate on the network makes the secret key not such a real secret. An unscrupulous user may still masquerade (and eavesdrop if SSL is not used) by obtaining the key from any legitimate device.

Secondly, the secret key solution fails to address security related to permitting foreign devices to temporarily operate on the wireless network. A foreign device can only operate on the network if the foreign device is provided with the secret key. And, once it has the key, all security provided by WEP is defeated until such time as the key is changed. Changing of the key in every access point and every client device on a periodic basis is cumbersome at best. A more advanced system assigns a distinct key to each device such that access may be denied to a single device without changing the secret key assigned to each other device. Devices known as enterprise class access points include WEP that support this feature, but again key management is cumbersome.

Another known attempt to restrict access to network services are password log-on systems. Network servers will only provide services to client devices that have been authenticated by user log-on name and password. More specifically, a user is assigned a login ID and a secret password. The user's login ID and password are also entered into a secure user database accessible to the server. To begin a session, the user establishes an SSL connection with the server and presents his or her logon name and password. If the logon name and password match those of an authorized user, then the server provides its services.

A short coming of user name and password systems is that the user must be authenticated (e.g. identified) and given his or her user name and password in a secure manner. Another short coming is that the user name and password must be entered into the database of each server that the user may use in a secure manner (e.g. enrolled with each server). Yet another short coming is that the authorized user is required to authenticate himself or herself (e.g. “logon”) to each server each time he or she begins a network session. This short coming is particularly relevant in a wireless network environment wherein the client may roam across multiple (sub)networks and be forced to periodically establish a new network session due to roaming. Upon roaming, the user would be required re-enter his or her logon name and password with each server.

An improvement over the user log-on name and password system is a centralized access granting system such as Kerberos. In such a system, the user logs onto to the authentication server only and the authentication server grants access to each of the servers providing services.

More specifically, the authentication server maintains a “secret key” for each authorized user and for each of the network services. The authentication server (or an access granting server controlled by the authentication server) will securely communicate with the user's device using the user's secret key and communicates with each of the network services through the user's device using the network service's secret key. By generating an ephemeral secret key (known as a session key), and by providing the session key to both the client device and to the network service, the authentication server and access granting server can effectively grant permission to the client device to utilize the network service so long as the network service accepts the encrypted credentials supplied from the user endpoint device. While such a system reduces the number of servers to which the user must log-on, the same short comings still exists, just to a lesser degree.

A digital certificate system enables two devices to mutually authenticate and communicate over secure channels without requiring either device to “logon” and maintain a session with an authentication server. After each device has obtained a digital certificate issued by a trusted certificate authority (that has not listed the certificate on a revocation list), such devices may, without any further communication with the certificate authority perform mutual authentication and encrypted communication. The possibility of either masquerading as a device or eavesdropping between two devices communicating using cryptography based on the public key contained in their digital certificates and the corresponding private key is statistically insignificant.

A digital certificate operates utilizing an asymmetric encryption system. An asymmetric encryption system has the following characteristics. There exists a cryptographic key pair, one public key and one private key. The encryption algorithm is irreversible—so that the original data can never be deciphered with the same key used to encrypt the data. The private encryption key can not be derived from the public encryption key in a computationally feasible manner. Data that is encrypted with the private key can only be deciphered using the public key. And, data that is encrypted with the public key can only be deciphered using the private key. Such systems typically rely on the fact that it is computationally infeasible to factor a large number, and the fact that it is impossible to reverse the result of a Modulo function to achieve the above.

The digital certificate binds a client's identity and public key to the client. More specifically, a trusted certificate authority builds a certificate for a client containing elements such as the client ID and the client's public key. The certificate authority then performs a one-way hash of the certificate, encrypts the hash value utilizing the certificate authority's private encryption key (a process known as signing), and then attaches the signature to the certificate. This signature on the certificate is readily validated by any device utilizing the certificate authority's public key published in the digital certificate of the certificate authority.

When a remote device receives a client's digital certificate, it obtains the client's ID and the client's public key. And, so long as the certificate authority is trusted by the remote device (i.e. the certificate authority's digital certificate is installed in the remote device), then the remote device is capable of validating the client's certificate and can be assured that only the client specified in the certificate has the ability to decipher any data encrypted with the client's public key. This prevents any other device which does not have access to the client's private key from eavesdropping. Likewise, the remote device can be assured that only the client specified in the certificate has the ability to encrypt data with the client's private key. Further, because the client certificate containing the client ID and public key came signed with the certificate authority's private key, so long as the certificate authority's public key was used to validate the signature on the certificate, the remote device is assured that the client certificate is legitimately signed by the trusted certificate authority. This prevents any other device from emulating the client and self generating a digital certificate and signature of a certificate authority.

By trading digital certificates, each device can authenticate the other to prevent masquerading by unscrupulous clients and to securely exchange data without eavesdropping by unscrupulous clients. However, a problem exists in that the certificate authority is responsible for validating the identity of the client before digitally signing a client's certificate. There currently exist several validation systems.

One technique requires the requestor to personally appear before a registration agent to verify the client's identity using public identity documents. In a less secure method, the registration agent may issue the signed certificate without verifying the client's identity, but encode the signed certificate with a secret key. The secret key is then mailed to the client at the address identified in the certificate application request. The integrity of the first method is based on an imposter not being able to fool the registration authority with false identity documents. The integrity of the second method is based on an imposter not being able to intercept mail sent to the client identified in the certificate request. Although not perfect, such security is viewed as adequate for many systems.

The problem with such systems is that they are time consuming. It is not practical to have every potential user of a wireless network system appear before a registration agent or wait for a mailed secret key. What is needed is an improved system for validating the identity of a user over an open network.

### SUMMARY OF THE INVENTION

A first aspect of the present invention is to provide a method of authenticating the identity of a user of an endpoint device over an open network. The method comprises: i) establishing a secure connection with the endpoint device; ii) obtaining the identity of the user of the endpoint device from the endpoint device over the secure connection; iii) obtaining an indication of a validation parameter associated with the user from a trusted database; iv) providing the endpoint device with authentication instructions, the authentication instructions identifying verification data to be provided by the endpoint device; v) receiving verification data from the endpoint device; and vi) determining that the identity of the user of the endpoint device is authentic if the verification data correlates to the validation parameter.

The open network may be an Internet Protocol (IP) network and the secure connection may be a secure socket layer (SSL) connection established between a registration agent and the endpoint device.

The validation parameter may be a biometric validation parameter. In such case, the trusted database stores, in association with the identity of the user, an indication that the validation parameter is a biometric validation parameter and a verification value identifying a biometric characteristic of the user. The step of determining that the identity of the user of the endpoint device is authentic if the verification data correlates to the validation parameter comprises comparing the verification data and the verification value and determining if the verification data is within an acceptable deviation from the verification value.

The validation parameter may be a location validation parameter. In such case, the trusted database stores, in association with the identity of the user, an indication that the validation parameter is a location validation parameter and a verification value which identifies a location that is known to be controlled by the user. The verification data is a location measured and/or calculated by a location module of the endpoint device. The step of determining that the identity of the user of the endpoint device is authentic if the verification data correlates to the validation parameter comprises comparing the location provided by the location module of the endpoint device to the verification value and determining if the location provided by the endpoint device is within an acceptable deviation from the verification value.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram representing a system for authenticating a user and securely providing access to proprietary network systems in accordance with one embodiment of the present invention;

FIG. 2a is a ladder diagram representing a first exemplary embodiment of the present invention;

FIG. 2b is a ladder diagram representing a second exemplary embodiment of the present invention;

FIG. 3 is a diagram representing an exemplary certificate request;

FIG. 4a is a table representing a validation database in accordance with a first embodiment of the present invention;

FIG. 4b is a table representing a validation database in accordance with a second embodiment of the present invention; and

FIG. 5 is a flow chart representing exemplary operation of a certificate request application in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of hardware circuit(s) and a processor and/or control block executing code.

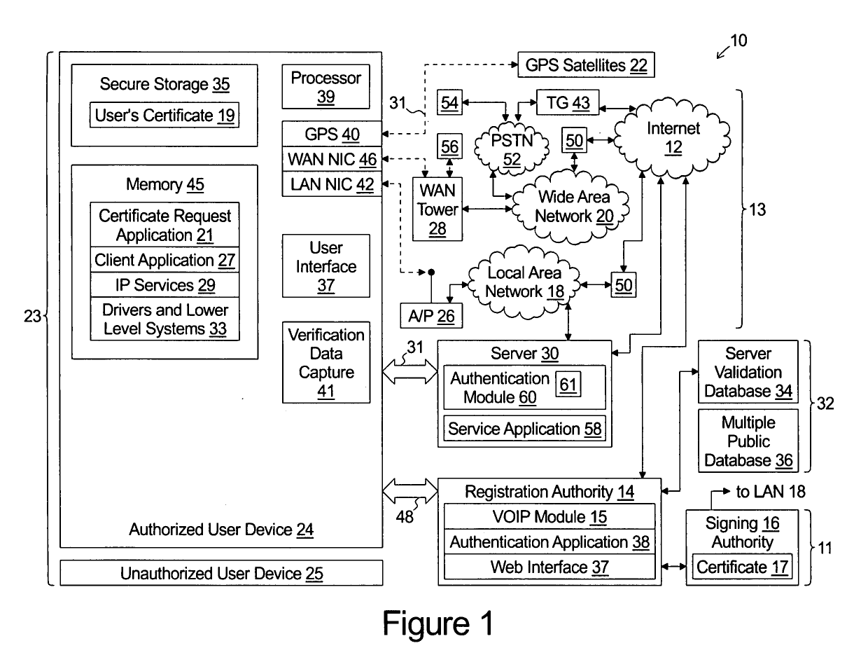

FIG. 1 represents a block diagram useful for discussing the system 10 for: i) authenticating a user; ii) securely providing network services to an authorized user endpoint device 24 operated by the user over an open network infrastructure 13; and iii) denying service to an unauthorized user endpoint device 25. For purposes of the discussion of this invention, authorized user endpoint devices 24 and unauthorized user endpoint devices 25 may be collectively referred to as user endpoint devices 23.

The open network infrastructure 13 may comprise the networks commonly referred to as the Internet backbone 12 and each of a local area network (LAN) 18 and a wide area network (WAN) 20. Each of the LAN 18 and the WAN 20 is coupled to the Internet 12 by a router or Network Address Translation (NAT) server 50 and each is capable of transferring IP frames.

The LAN 18 may be controlled by a local area network provider and include at least one wireless access point 26 for routing IP frames between a plurality of user endpoint devices 23 and other devices coupled to the LAN 18 or the Internet 12.

The WAN 20 may be controlled by a wide area network service provider and include at least one wireless tower 28 for routing IP frames between a user endpoint device 23 and the Internet 12. In addition to being coupled to the Internet 12, the WAN may be coupled to the public switched telephone network (PSTN) 52 and the wireless tower(s) 28 may route proprietary frames (representing digital audio) between: i) a wireless telephone 56 or a user endpoint device 23 that is equipped with wireless telephone capabilities and assigned a PSTN telephone number; and ii) the PSTN 52 or other wireless telephones 56 or wireless telephone equipped user endpoint devices 23.

A trunking gateway 50 may couple between the Internet 12 and the PSTN 52 to facilitate mixed media calls between VoIP Internet Protocol (VoIP) telephone call legs over the Internet 12 and PSTN telephone call legs to land line subscriber loops 54 on the PSTN 52 or to wireless telephones 56 or wireless telephone equipped user endpoint devices 23.

The network services are provided by one or more proprietary systems servers 30. Each proprietary systems server 30 is coupled to either the LAN 18 or to the Internet 12. Each proprietary systems server 30 provides its network services to authenticated users of authorized user endpoint devices 24 while denying access to unauthorized user endpoint devices 25. Exemplary network services provided by the proprietary systems servers 30 may comprise email services, print services, file storage services, Internet gateway services, and other services that would typically only be provided to authenticated users.

The propriety systems server 30 comprises a service application 58 for performing the network services and an authentication module 60 for limiting access to only those users that have been properly authenticated.

In the exemplary embodiment, a user of an authorized user endpoint device 24 and the authentication module 60 mutually authenticate each other and establish a secure connection by exchanging digital certificates using techniques known in the art. More specifically, the authorized user endpoint device 24 sends a copy of its user's certificate 19 to the authentication module 60 and the authentication module 60 sends a copy of its certificate 61 to the user endpoint device 24. Because each certificate has been signed (e.g. encrypted) by a certificate authority trusted by both the endpoint device 24 and the server 30, both the authorized user endpoint device 24 and the server 30 are assured that the other device is what it purports to be (e.g there is no masquerading).

Certificate Authority

The system 10 includes a certificate authority 11 for authenticating the user and signing the user's certificate 19 such that the user may access the proprietary systems server 30 as discussed above. The certificate authority 11 is coupled to either the Internet 12 or the local area network 18. The certificate authority 11 comprises a registration agent 14, a certificate signing authority 16, and at least one trusted database 32.

The registration agent 14 of the certificate authority 11 is responsible for receiving a certificate signing request from a user endpoint device 23, verifying the identity of the user endpoint device 23, having the user's digital certificate 19 signed by the certificate signing authority 16 thereby binding the user's public key to the authenticated user, and delivering the signed digital certificate 19 to the user endpoint device 23 thereby making such user endpoint device 23 an authorized user endpoint device 24.

The certificate signing authority 16 may be a known certificate signing system that itself is either a root certificate or has a digital certificate 17 from a higher level trusted certificate authority (not shown).

The trusted database 32 may be a secure validation database 34 securely coupled to the registration agent 14 or may be a plurality of public databases 36 wherein the data can be considered trusted if it is verifiable across the multiple well known public databases 36, each controlled by a distinct entity with an incentive to maintain the integrity of the public database 36.

The registration agent 14 may comprise an authentication application 38, a web interface 37, and a VoIP module 15. The web interface 37 provides for establishing a secure sockets connection (SSL) with a user endpoint device 23 for securely communicating with the user endpoint device 23 in accordance with the present invention.

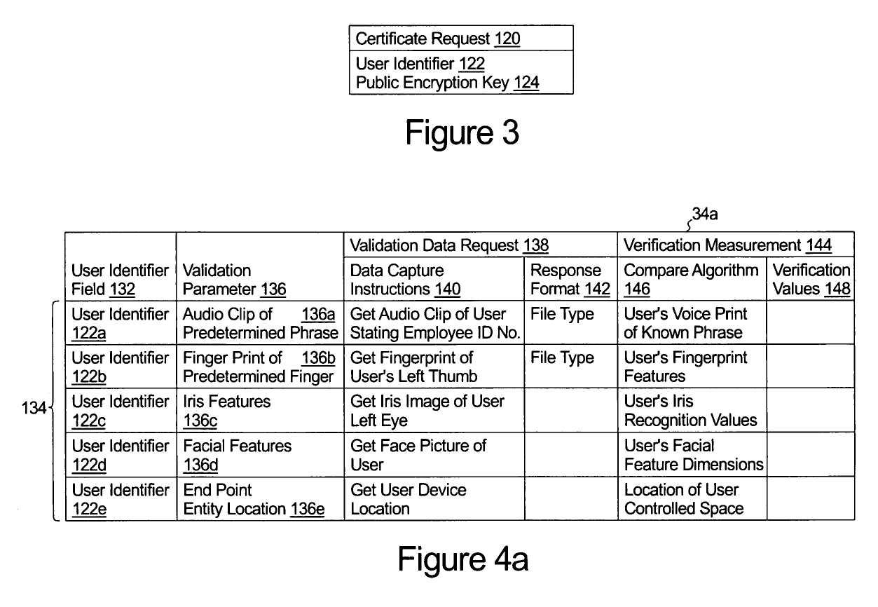

The authentication application 38 receives the certificate signing request from the user endpoint device 23. Turning briefly to FIG. 3 in conjunction with FIG. 1, the certificate signing request 120 includes a user identifier 122 which is an indication of the identity of the user of the user endpoint device 23, and a public encryption key 124 of a public/private key pair generated by the user endpoint device 23 for the user.

The authentication application 38 determines whether the user identifier 122 is the authentic identity of the user utilizing an authentication system described herein. If the user identifier 122 is not authentic, the certificate signing request 120 is denied. If the user identifier 122 is determined to be the authentic identity of the user, then the registration agent 14: i) requests signing of the user's digital certificate 19 by the certificate signing authority 16, ii) obtains the signed user's digital certificate 19 from the certificate signing authority 16, and iii) returns the signed user's digital certificate to the user endpoint device 23 thereby making the user endpoint device 23 an authorized user endpoint device 24.

In Band Validation

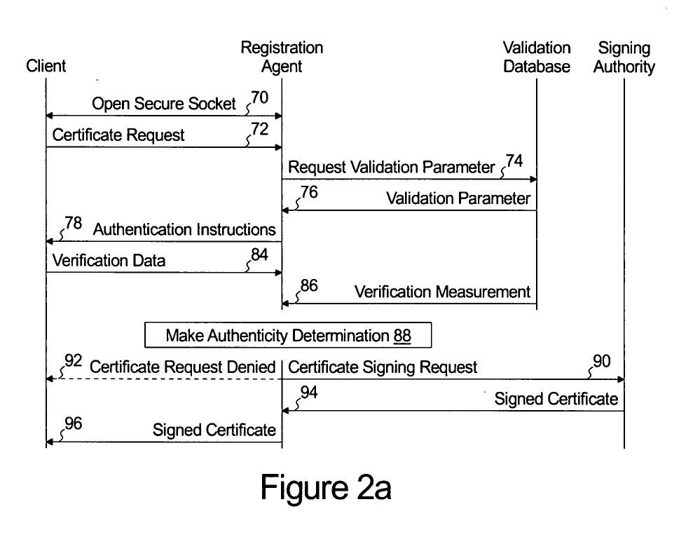

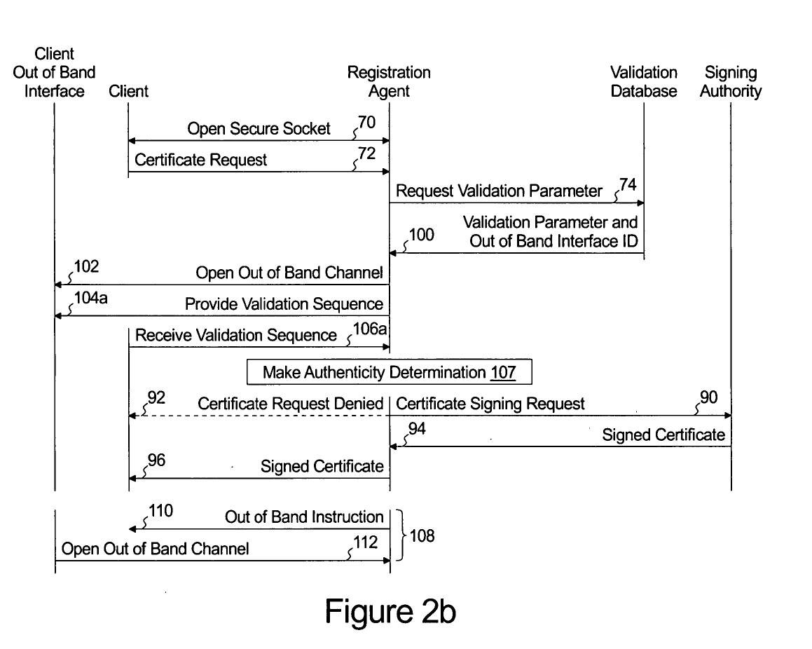

The ladder diagram of FIG. 2a represents a first embodiment of operation of the authentication application 38 of the present invention. Referring to the ladder diagram of FIG. 2a in conjunction with FIG. 1, step 70 represents opening a secure socket layer connection with a certificate requesting application 21 running on the user endpoint device 23.

Step 72 represents receiving the certificate signing request 120 from the certificate requesting application 21. As discussed with respect to FIG. 3, the certificate signing request 120 includes the user identifier 122 which identifies the purported user of the user endpoint device 23 and a public encryption key 124 generated by the certificate requesting application 21 for the user.

Also as previously discussed, the registration agent 14 is responsible for validating the purported identity of the user. Step 74 represents requesting a validation parameter 136 from the secure validation database 34.

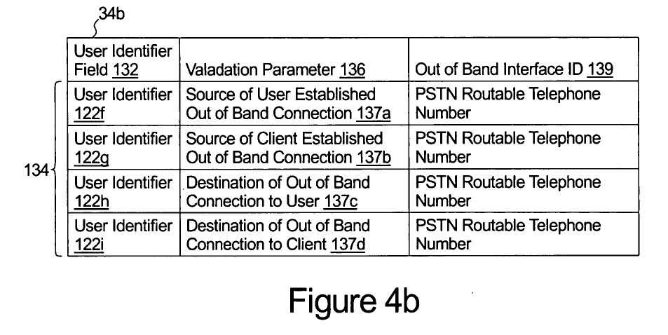

The table diagram of FIG. 4a, represents a first exemplary secure validation database 34a. The database 34a includes a plurality of records 134 each of which includes a user identifier field 132. Within the user identifier field 132 of each record 134 is a user identifier 122a-122e. Each user identifier 122a-122e uniquely associates with one of the potential users. Associated with each user identifier 122a-122e is at least one validation parameter 136 that can be used to validate whether a purported user truly is who he or she purports to be.

The validation parameter 136 identifies a measurement, calculation, or other characteristic that that may be used by the authentication application 38 to determine whether the user identifier 122 indicating the identity of the user is the authentic identity of the user of the user endpoint device 23. Exemplary validation parameters 136 comprise biometric validation parameters and location validation parameters. Exemplary biometric validation parameters comprise: i) validation of an audio clip of the user stating a predetermined phrase 136a; ii) validation of the user's finger print 136b; iii) validation of the user's iris features 136c; and iv) validation of the user's facial features 136d. An exemplary location validation parameter comprises validation of the user endpoint device's location 136e (such as within the user's home).

Step 78 represents providing a validation data request 138 to the user endpoint device 23. More specifically, the validation database 34 may include a validation data request 138 in association with each validation parameter 136. The validation data request 138 may comprise data capture instructions 140 and response format instructions 142.

The data capture instructions 140 include instructions useful by the user endpoint device 23 for measuring, calculating, or otherwise capturing verification data. The response format instructions 142 may specify a file type, compression algorithms, and other rules for formatting the verification data and providing the verification data to the registration agent 14.

For example, if the validation parameter 136 is validation of an audio clip of the user stating a predetermined phrase 136a, then the data capture instructions 138 may be instructions to capture an audio clip of the user stating his or her employee number and the response format instructions 142 may specify both a file type and an audio compression algorithm.

If the validation parameter 136 is validation of the user's finger print 136b; then the data capture instructions 138 may be instructions to capture a finger print image of the user's left thumb and the response format instructions 142 may specify a file type and either a compression algorithm or specific measurements required.

If the validation parameter 136 is validation of the user's iris features 136c, then the data capture instructions 138 may be instructions to capture an image of the user's left eye and the response format instructions 142 may specify a file type and an image compression algorithm.

If the validation parameter 136 is validation of the user's facial features 136d, then the data capture instructions 138 may be instructions to capture an image of the user's face and the file format instructions 142 may specify a file type and an image compression algorithm.

If the validation parameter 136 is validation of the user endpoint device's location 136e; then the data capture instructions 138 may be instructions to determine the current location of the user endpoint device 23 utilizing i) positioning signals 31 provided by a global positioning system (GPS) 22 or ii) position information provided by the WAN Tower 28, and the response format instructions 142 may specify a format for providing the current location to the registration agent 14.

Step 84 represents the registration agent 14 receiving the verification data provided by the client device 23 in the specified response format 142. Step 86 represents obtaining a verification measurement 144 from the validation database 34. The verification measurement 144 may comprise both a comparison algorithm 146 and verification values 148.

Step 88 represents the registration agent 14 determining whether the user identifier 122 provided in the certificate signing request 120 is the authentic identity of the user of the user endpoint device 23 by determining whether the verification data provided by the user endpoint device 23 is within acceptable deviation of the verification values 148.

For example, if the validation parameter 136 is validation of an audio clip of the purported user stating a predetermined phrase 136a, then the verification values 148 may represent speed, tone, pitch, or measurements of other speech characteristics made of a previous recording of the user stating the phrase in a controlled environment and the comparison algorithm 146 may be an algorithm for taking similar measurements of the verification data and determining whether the measurements of the verification data are within an acceptable deviation of the verification values 148.

If the validation parameter 136 is validation of the a finger print 136b of the purported user; then the verification values 148 may be relative placement of fingerprint features or measurements of other fingerprint characteristics made of the fingerprint of the user previously taken in a controlled environment and the comparison algorithm 146 may be an algorithm for taking similar measurements of the verification data and determining whether the measurements of the verification data within an acceptable deviation of the verification values 148.

If the validation parameter 136 is validation of iris features 136c of the purported user, then the verification values 148 may be measurements of iris features made of an image of the eye of the user that was previously captured in a controlled environment and the comparison algorithm 146 may be an algorithm for taking similar measurements of the verification data and determining whether the measurements of the verification data within an acceptable deviation of the verification values 148.

If the validation parameter 136 is validation of facial features 136d of the purported user, then the verification values 148 may be relative placement of distinguishing facial features or measurements of other facial features made of an image of the face of the that was taken in a controlled environment and the comparison algorithm 146 may be an algorithm for taking similar measurements of the verification data and determining whether the measurements of the verification data within an acceptable deviation of the verification values 148.

If the validation parameter 136 is validation of the location 136e of the purported user; then the verification values 148 may identify a location determined to be controlled by the user (such as the user's home) and the comparison algorithm 146 may be an algorithm for comparing whether the location specified in the verification data is within an acceptable deviation of the verification values 148. In any such case, if the verification data matches the verification values 148, it can be concluded that the purported user is the user associated with the user identifier 122 provided in the certificate request 120. Or, stated another way, the user is authenticated and the registration agent 14 passes a certificate signing request 120 to the certificate signing authority 16 at step 90. Alternatively, if the purported user is not authenticated, the certificate singing request is denied at step 92.

Step 94 represents receiving the signed user's certificate 19 back from the certificate signing authority 16 and step 96 represents providing the signed user's certificate 19 to the user endpoint device 23.

In a second embodiment of the authentication system described with respect to the ladder diagram of FIG. 2a and the validation database 34 of FIG. 4a, the verification values 148 may not be included in the validation database 34. Instead, the verification values 148 may be provided by one or more public databases 36. In which case, the comparison value 148 within the validation database 34 will be a public data base look up query 37.

For example if the validation parameter 136 is validation of the location 136e of the purported user; then the verification value 148 may be a query to look up the location of the home of the user in one or more public databases 36. The integrity of the data provided by a public database 36 is based on the premises that the data is valid if it is verifiable across multiple public databases 36, each of which is independently controlled by an entity that has motivation to control its integrity.

Out of Band Channel Validation

The ladder diagram of FIG. 2b represents a second embodiment of operation of the authentication application 38 of the present invention. Referring to the ladder diagram of FIG. 2b in conjunction with FIG. 1, steps 70 through 74, as previously discussed with reference to FIG. 2a, represent opening a secure socket layer connection with the certificate requesting application 21 running on the user endpoint device 23, receiving the certificate signing request 120 (FIG. 3) from the user endpoint device 23, and requesting a validation parameter 136 from the secure validation database 34 respectively.

The table diagram of FIG. 4b represents a second exemplary secure validation database 34b. The database 34b includes a plurality of records 134 each of which includes a user identifier field 132. Within the user identifier field 132 of each record 134 is a user identifier 122f-122i. Each user identifier 122f-122i uniquely associates with one of the potential users. Associated with each user identifier 122f-122i is at least one validation parameter 136 that can be used to validate whether a purported user is who he or she purports to be.

As discussed with respect to FIG. 4a, the validation parameter 136 identifies a method that that may be used by the authentication application 38 to determine whether the user identifier 122 indicating the identity of the user is the authentic identity of the purported user of the user endpoint device 23. Exemplary validation parameters 136 set forth in this second embodiment comprise: i) validation of the source of a user established out of band connection 137a established by the user to the registration agent 14; ii) validation of the source of a client established out of band connection 137b established by the client device 23 to the registration agent 14; iii) validation of the destination of an out of band connection 137c established by the registration agent 14 to the user; and iv) validation of the destination of an out of band connection 137d established by the registration agent 14 to the client device 23.

Also associated with each record 134 is an out of band interface ID 139 that is used for verifying the source or destination of the out of band connection. Step 100 represents receiving the validation parameter 136 and the out of band interface ID 139 from the validation database 34b.

Destination Validation Parameter

In the case wherein the validation parameter 136 is a destination of an out of band connection to the user, step 102 represents opening such out of band channel utilizing the out of band interface ID 139.

For example in a case wherein the out of band interface ID 139 is a PSTN routable telephone number known to be associated with a land based subscriber loop 54 to the home of the user, then step 102 represents placing a telephone call to such PSTN routable telephone number. The telephone call may be initiated by the VoIP module 15 of the registration agent 14 and routed as a VoIP call leg to the PSTN trunking gateway 50 and routed as a PSTN call leg from the trunking gateway 50 to the home of the user.

In a case wherein the out of band interface ID 139 corresponding to the user identifier 122 in the validation database 34b is a PSTN routable telephone number known to be associated with a user endpoint device 23 or a wireless telephone 56 controlled by the user, then step 102 represents placing a telephone call to such PSTN routable telephone number. The telephone call may be initiated by the VoIP module 15 of the registration agent 14 and routed as a VoIP call leg to a gateway controlled by the WAN service provider (not shown) and routed utilizing the WAN proprietary audio frame format to the user endpoint device 23 or the wireless telephone 56. Alternatively, the telephone call may be initiated by the VoIP module of the registration agent 14 and routed as a VoIP call to the PSTN trunking gateway 50, routed as a PSTN call leg from the trunking gateway 50 to the WAN service provider gateway, and routed utilizing the WAN proprietary audio frame format to the user endpoint device 23 or the wireless telephone 56.

After the out of band channel has been opened to an out of band interface ID 139 known to be associated with the user, authentication of the user comprises providing a validation sequence to the user over the out of band channel at step 104 and receiving the validation sequence back from the certificate requesting application 21 of the user endpoint device 23 at step 106.

For example, the validation sequence may be a random number generated by the registration agent 14. Step 104a represents providing the validation sequence to the user by synthesized voice reading the sequence over the out of band channel and step 106a represent receiving the sequence from the user endpoint device 23 over the secure socket connection. In the situation wherein the out of band channel is to a land line subscriber loop or to a wireless device 56, the user may listen to the synthesized voice reading the sequence and manually enter the sequence into the certificate requesting application utilizing a user interface 37 of the user endpoint device 23. In the situation wherein the out of band channel is to the user endpoint device 23, the sequence may be provided in a digital format and transferred from the WAN transceiver 46 to the certificate requesting application 21.

In a first alternative embodiment step 104b represents providing the validation sequence to the user endpoint device 23 over the secure connection 48 and step 106a represent receiving the sequence back through the out of band channel. In the situation wherein the out of band channel is to a land line subscriber loop or to a wireless device 56, the certificate requesting application 21 may display the validation sequence on the user interface 37 of the user endpoint device 23 such that the user reads and speaks the validation sequence over the out of band channel. In the situation wherein the out of band channel is to the user endpoint device 23, the sequence may be provided in a digital format and transferred from the secure connection to the WAN transceiver 46 by the certificate requesting application 21.

Following receipt of the validation sequence back from the certificate requesting application 21 (or the user via the out of band channel), step 107 represents making an authenticity determination. The authenticity of the user identifier 122 comprises determining that the validation sequence received matches the validation sequence provided.

If the user identifier 122 provided in the certificate request 120 is not authentic, the certificate request is denied at step 92. If the user identifier 122 provided in the certificate request 120 is authentic, the registration agent 14 passes a certificate signing request to the certificate signing authority 16 at step 90. Step 94 represents receiving the signed certificate back from the certificate signing authority 16 and step 96 represents providing the certificate to the user endpoint device 23.

In an alternative variation of the authentication systems described above, with reference to the validation database 34b of FIG. 4b, the out of band interface ID 139 may not be included in the validation database 34b. Instead, the out of band interface ID 139 may be provided by one or more public databases 36. In which case, out of band interface ID 139 within the validation database 34b will be a public data base look up query.

As yet another alternative variation of the authentication systems described above, the user identifier 122 may include a telephone number provided by the requestor. The process of looking up an out of band interface ID 139 may further comprise verifying that the out of band interface ID 139 associated with the user matches the telephone number provided with the user identifier 122.

Source Validation Parameter

In the case wherein the validation parameter 136 is a source of a user established out of band connection, step 102 is replaced by steps 110 and 112 in the ladder diagram of FIG. 2b. More specifically, step 110 represents providing an out of band instruction to the user endpoint device 23 and step 112 represents opening an out of band channel initiated by the user.

For example in a case wherein the out of band interface ID 139 corresponding to the user identifier 122 in the validation database 34b is a PSTN routable telephone number known to be associated with a land based subscriber loop 54 to the home of the user, then step 110 represents providing an instruction for the user to place a telephone call to the registration agent 14 (at a PSTN routable telephone number associated with the registration agent 14) from the identified PSTN subscriber loop. The telephone call initiated on the subscriber loop may be routed to the registration agent over a combination of the PSTN 52 and the Internet 12 if inbound Internet telephony service is available to the registration agent 14.

In a case wherein the out of band interface ID 139 is a PSTN routable telephone number known to be associated with a wireless telephone 56 controlled by the user, then step 110 represents providing an instruction for the user to place a telephone call to the registration agent 14 (at a PSTN routable telephone number associated with the registration agent 14) from the identified wireless telephone. The telephone call initiated using the wireless telephone 56 may be routed to the registration agent 14 over a combination of the WAN 20 and either the PSTN 52 or the Internet 12 if inbound Internet telephony service is available to the registration agent 14.

In a case wherein the out of band interface ID 139 is a PSTN routable telephone number known to be associated with the user endpoint device 23 controlled by the user, then step 110 represents providing an instruction for the user endpoint device 23 to utilize its WAN transceiver 46 to place a telephone call to the registration agent 14 (at a PSTN routable telephone number associated with the registration agent 14). The telephone call initiated using the user endpoint device 23 may be routed to the registration agent 14 over a combination of the WAN 20 and either the PSTN 52 or the Internet 12 if inbound Internet telephony service is available to the registration agent 14.

In any of the above cases, step 112 represents opening and verifying the out of band channel by “answering” the inbound telephone call and comparing a caller ID number provided by a telephony service provider to the out of band interface ID 139 corresponding to the user identifier 122 in the validation database 34b.

If the out of band channel can not be verified, then the certificate request is denied at step 92. If the out of band channel is verified, the registration agent 14 passes a certificate signing request to the certificate signing authority 16 at step 90. Step 94 represents receiving the signed certificate back from the certificate signing authority 16 and step 96 represents providing the certificate to the user endpoint device 23.

In an alternative variation of the authentication systems described above, with reference to the validation database 34b of FIG. 4b, the out of band interface ID 139 may not be included in the validation database 34b. Instead, the out of band interface ID 139 may be provided by one or more public databases 36. In which case, out of band interface ID 139 within the validation database 34b will be a public data base look up query.

As yet another alternative variation of the authentication systems described above, the user identifier 122 may include a telephone number provided by the requestor. The process of looking up an out of band interface ID 139 may further comprise verifying that the out of band interface ID 139 associated with the user matches the telephone number provided with the user identifier 122.

User Endpoint Device

Returning to FIG. 1, an exemplary user endpoint device 23 useful for implementing the invention described herein includes a processor 39 executing code stored in a memory 45 and a plurality of peripheral circuits interconnected with the processor by applicable bus systems.

In the exemplary embodiment, the peripheral systems may include: i) a wireless LAN transceiver 42 for communicating with the access point 26 of the LAN 18; ii) a wireless WAN transceiver 46 for communicating both IP compliant data frames and proprietary wireless telephony frames with the WAN tower 28; iii) a GPS receiver for determining the location of the user endpoint device 23 utilizing the positioning signals 31; iv) at least one verification data capturing system 41 such as a digital camera, a finger print imaging system, an iris imaging system, a signature capture digitizer, or a microphone; and v) a user interface such as a touch panel display or display and keypad.

It should be appreciated that some of the verification data capturing system may include or share components with the user interface. For example, a touch panel display may be used for capturing a signature of a user.

The software modules executed by the processor from memory may include drivers and lower level systems 33 such as an operating system applicable for the processor 39 and hardware implementation of the user endpoint device 23 and drivers applicable for each of the peripheral systems. The software modules may further include: i) a network communication module 29 which may be a known in the art TCP/IP stack for implementing the TCP/IP Protocols and the TLS Protocols for establishing the secure socket connections discussed herein, ii) various client applications 27 for connecting to and operating the network services provided by each of the proprietary systems server 30, iii) a certificate requesting application 21, and iv) means for securely storing the user's private key and signed user certificate 19.

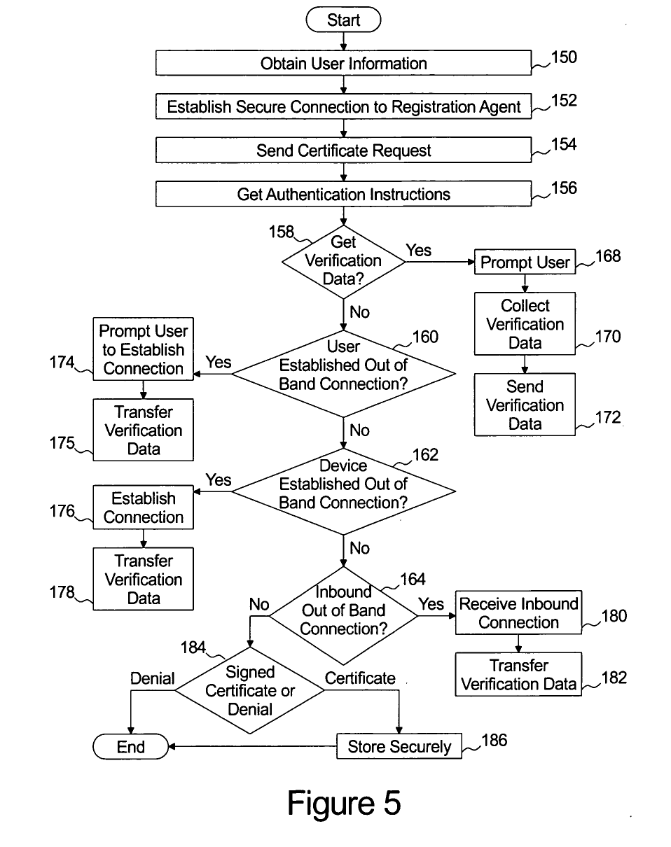

Turning briefly to FIG. 5, a flow chart representing exemplary operation of the certificate requesting application 21 is shown. Step 150 represents obtaining the user identifier 122 from the user. This may be accomplished through the user interface 37.

Step 152 represents establishing a secure TCP/IP connection to the registration agent 14 by initiating the TCP/IP three way “hand-shaking” message exchange for establishing a TCP/IP connection and thereafter initiating the TLS “hand-shaking” to secure the connection.

Step 154 represents generating a public/private cryptography key pair and sending the certificate request 120 to the registration agent 14. As previously discussed with reference to FIG. 3, the certificate request 120 comprises the user identifier 122 and the public cryptography key 124 generated for the user to be bound to the user upon signing of the user's certificate 19.

Step 156 represents receiving authentication instructions from the registration agent 14. The authentication instructions may comprise any of: i) the validation data request 138, ii) the out of band interface ID 139; or receiving an out of band connection established to the user endpoint device 23 established by the registration agent 14.

The validation data request 138 may define verification data required to be provided by the endpoint device 23. More specifically, the validation data request 139 may comprise data capture instructions 140 for capturing or measuring verification data and response format instructions 142 previously discussed with respect to FIG. 4a. If a validation data request 138 is received at step 156, as determined at decision box 158, the certificate request application 21 prompts the user, at step 168, to provide the requested data such as by speaking a predetermined phrase into a microphone peripheral, photographing himself or herself, placing his or her finger on a finger print capture peripheral, imaging his or her iris, signing his or her name on a digitizer peripheral, or providing a validation sequence given to the user via an out of band channel established by the registration agent.

Then at step 172, the captured data is formatted as per the response file format 142 provided by the registration agent 14. The certificate request application 21 then proceeds to step 184 where it waits for the signed user certificate 19 or a denial of the signing request.

The out of band interface ID 139 may be either an instruction to prompt the user to establish an out of band connection to a PSTN routable telephone number associated with the registration agent 14 or may be an instruction to cause the user endpoint device 23 itself to establish an out of band connection to a PSTN routable telephone number associated with the registration agent 14.

If the authentication instruction received at step 156 is an instruction to prompt the user to establish an out of band connection to a PSTN routable telephone number associated with the registration agent 14, as determined at decision box 160, then the certificate request application 21 writes the required prompt to the user interface 37 for communication to the user at step 174.

Step 175 then represent transferring verification data which may include either: i) receiving verification data via the user interface 37 from the user and transferring such verification data to the registration agent 14 over the secure connection 48; or ii) receiving verification data from the registration agent 14 over the secure connection 48 and writing such verification data to the user interface 37 for communication to the user such that the user may forward such verification data back to the registration agent over the out of band channel. After transferring verification data, the certificate request application 21 then proceeds to step 184 where it waits for the signed user certificate 19 or a denial of the signing request.

If the authentication instruction received at step 156 is an instruction to cause the user endpoint device 23 to establish an out of band connection to a PSTN routable telephone number associated with the registration agent 14, as determined at decision box 162, then the certificate request application 21 utilizes the WAN network interface 40 to initiate a wireless telephone call to the designated PSTN routable telephone number at step 176.

Step 178 then represents transferring verification data which may include either: i) receiving verification data via the WAN network interface 40 and transferring such verification data back to the registration agent 14 over the secure connection 48; or ii) receiving verification data from the registration agent 14 over the secure connection 48 and transferring such verification data back to the registration agent 14 over the out of band channel via the WAN network interface 40. Again, after transferring verification data, the certificate request application 21 then proceeds to step 184 where it waits for the signed user certificate 19 or a denial of the signing request.

If the authentication instruction received at step 156 includes receipt of an out of band connection established by the registration agent 14 to the user endpoint device 23, as determined at step 164, then the certificate request application 21 receives the out of band connection at step 180 and transfers verification data at step 182. Again, the transfer of verification data may include either: i) receiving verification data via the WAN network interface 40 and transferring such verification data back to the registration agent 14 over the secure connection 48; or ii) receiving verification data from the registration agent 14 over the secure connection 48 and transferring such verification data back to the registration agent 14 over the out of band channel via the WAN network interface 40. Again, after transferring verification data, the certificate request application 21 then proceeds to step 184 where it waits for the signed user certificate 19 or a denial of the signing request.

Decision box 184 represents receiving either a denial of the certificate signing request or receipt of the signed user certificate 19. If a signed user certificate 19 is received, step 186 represents storing the signed user certificate 19 in the secure storage 35.

Because the teachings of the present invention provide for authenticating a user and enabling an authorized user endpoint device 24 to access proprietary services, it is important that the authorized user endpoint device 24 remain associated with the authenticated user and that the authorized user endpoint device 24 be converted to an unauthorized user endpoint device 25 if its association with the authenticated user is severed. As such, in one exemplary embodiment, the secure storage 35 is a smart card or other non-volatile memory removable from the authorized user endpoint device 24. Upon removal of the smart card secure storage 35, the authorized user endpoint device 24 no longer has the signed user's certificate 19 and therefore is an unauthorized user endpoint device 25.

In summary, it should be appreciated that the systems and methods provided for authenticating a user enable secure and authenticated access to proprietary access to proprietary network services without the disadvantages of known systems. Although the invention has been shown and described with respect to certain exemplary embodiments, it is obvious that equivalents and modifications will occur to others skilled in the art upon the reading and understanding of the specification. The present invention includes all such equivalents and modifications, and is limited only by the scope of the following claims.

1. A method of authenticating the identity of a user of an endpoint device over an open network, the method comprising:
establishing a secure connection with the endpoint device;
obtaining the identity of the user of the endpoint device from the endpoint device over the secure connection;
obtaining an indication of a validation parameter associated with the user from a trusted database;
providing the endpoint device with authentication instructions, the authentication instructions identifying verification data to be provided by the endpoint device;
receiving verification data from the endpoint device;
determining that the identity of the user of the endpoint device is authentic if the verification data correlates to the validation parameter.

2. The method of claim 1, wherein the open network is an Internet Protocol network and the secure connection is a secure socket layer connection established between a registration agent and the endpoint device.

3. The method of claim 2, wherein:
the validation parameter is a biometric validation parameter;
the trusted database stores, in association with the identity of the user, an indication that the validation parameter is a biometric validation parameter and a verification value identifying a biometric characteristic of the user; and
the step of determining that the identity of the user of the endpoint device is authentic if the verification data correlates to the validation parameter comprises comparing the verification data and the verification value and determining if the verification data is within an acceptable deviation from the verification value.

4. The method of claim 2, wherein:
the validation parameter is a location validation parameter;
the trusted database stores a verification value identifying a location in association with the identity of the user and an indication of the validation parameter; and
the step of determining that the identity of the user of the endpoint device is authentic if the verification data correlates to the validation parameter comprises comparing the location provided by the endpoint device to the verification value stored in the trusted database and determining if the location provided by the endpoint device is within an acceptable deviation from the verification value.

5. A method of providing a signed digital certificate to authenticate the identity of a user of an endpoint device over an open network, the method comprising:
establishing a secure connection with the endpoint device;
obtaining a digital certificate signature request from the endpoint device over the secure connection, the digital certificate request comprising an indication of the identity of the user of the endpoint device and a public encryption key;
obtaining an indication of a validation parameter associated with the user from a trusted database;
providing the endpoint device with authentication instructions, the authentication instructions identifying verification data to be provided by the endpoint device;
receiving verification data from the endpoint device;
providing a signed digital certificate to the endpoint device over the secure connection only if the verification data correlates to the validation parameter, the signed digital certificate including the indication of the identity of the user of the endpoint device, and a digital signature of a trusted certificate authority.

6. The method of claim 5, wherein the open network is an Internet Protocol network and the secure connection is a secure socket layer connection established between an registration agent and the endpoint device.

7. The method of claim 6, wherein
validation parameter is a biometric validation parameter;
the trusted database stores, in association with the identity of the user, an indication that the validation parameter is a biometric validation parameter and a verification value identifying a biometric characteristic of the user; and
the step of determining that the identity of the user of the endpoint device is authentic if the verification data correlates to the validation parameter comprises comparing the verification data and the verification value and determining if the verification data is within an acceptable deviation from the verification value.

8. The method of claim 7, wherein:
the validation parameter is a location validation parameter;
the trusted database stores a verification value identifying a location in association with the identity of the user and an indication of the validation parameter; and
the step of determining that the identity of the user of the endpoint device is authentic if the verification data correlates to the validation parameter comprises comparing the location provided by the endpoint device to the verification value stored in the trusted database and determining if the location provided by the endpoint device is within an acceptable deviation from the verification value.

9. A system for authenticating the identity of a user of an endpoint device over an open network comprising:
a web interface for establishing a secure connection with the endpoint device and obtaining the identity of the user of the endpoint device from the endpoint device over the secure connection;
a trusted database storing an indication of a validation parameter associated with the user;
an authentication application for:
obtaining the indication of a validation parameter associated with the user from the trusted database;
providing the endpoint device with authentication instructions over the secure connection established by the web interface; the authentication instructions identifying verification data to be provided by the endpoint device;
receiving verification data from the endpoint device over the secure connection established by the web interface;
determining that the identity of the user of the endpoint device is authentic if the verification data correlates to the validation parameter.

10. The system for authenticating the identity of a user of an endpoint device over an open network of claim 9, wherein the open network is an Internet Protocol network and the secure connection is a secure socket layer connection established between an registration agent and the endpoint device.

11. The system for authenticating the identity of a user of an endpoint device over an open network of claim 10, wherein:
the validation parameter is a biometric validation parameter;
the trusted database stores, in association with the identity of the user, an indication that the validation parameter is a biometric validation parameter and a verification value identifying a biometric characteristic of the user; and
the authentication application further provides for:
comparing the verification data and the verification value and determining if the verification data is within an acceptable deviation from the verification value to determine that the identity of the user of the endpoint device is authentic.

12. The system for authenticating the identity of a user of an endpoint device over an open network of claim 10, wherein:
the validation parameter is a location validation parameter;
the trusted database stores a verification value identifying a location in association with the identity of the user and an indication of the validation parameter; and
the authentication application further provides for:
comparing the location provided by the endpoint device to the verification value stored in the trusted database and determining if the location provided by the endpoint device is within an acceptable deviation from the verification value to determine that the identity of the user of the endpoint device is authentic.

13. A system for providing a digital certificate authenticating the identity of a user of an endpoint device over an open network, the system comprising:
a web interface (37) for establishing a secure connection with the endpoint device and obtaining a digital certificate request from the endpoint device, over the secure connection, the digital certificate request comprising an indication of the identity of the user of the endpoint device and a public encryption key;
a trusted database (32) storing an indication of a validation parameter associated with the user;
an authentication application for:
obtaining an indication of a validation parameter associated with the user from a trusted database;
providing the endpoint device with authentication instructions, the authentication instructions identifying verification data to be provided by the endpoint device;
receiving verification data from the endpoint device;
providing a signed digital certificate to the endpoint device over the secure connection only if the verification data correlates to the validation parameter, the signed digital certificate including the indication of the identity of the user of the endpoint device, the public encryption key, and a digital signature of a trusted certificate authority.

14. The system for providing a digital certificate authenticating the identity of a user of an endpoint device and over an open network of claim 13, wherein the open network is an Internet Protocol network and the secure connection is a secure socket layer connection established between an registration agent and the endpoint device.

15. The system for providing a digital certificate authenticating the identity of a user of an endpoint device and over an open network of claim 14, wherein:
validation parameter is a biometric validation parameter;
the trusted database stores, in association with the identity of the user, an indication that the validation parameter is a biometric validation parameter and a verification value identifying a biometric characteristic of the user; and
the authentication application further provides for:
comparing the verification data and the verification value and determining if the verification data is within an acceptable deviation from the verification value to determine that the identity of the user of the endpoint device is authentic.

16. The system for providing a digital certificate authenticating the identity of a user of an endpoint device and over an open network of claim 14, wherein:
the validation parameter is a location validation parameter;
the trusted database stores a verification value identifying a location in association with the identity of the user and an indication of the validation parameter; and
the authentication application further provides for:
comparing the location provided by the endpoint device to the verification value stored in the trusted database and determining if the location provided by the endpoint device is within an acceptable deviation from the verification value to determine that the identity of the user of the endpoint device is authentic.

17. A system for providing network services to an endpoint device over an open network, the system comprising:
a proprietary services server for providing network services to an endpoint device, the proprietary services server comprising:
a services application for providing network services to the endpoint device in response to an authentication module providing an indication that the endpoint device is authentic;
an authentication module for:
receiving a session request from the endpoint device;
obtaining a digital certificate from the endpoint device;
providing the indication that the endpoint device is authentic only if the digital certificate identifies an authorized user and is signed by a trusted certificate authority;
providing the endpoint device with an instructions to contact an registration agent if the endpoint device fails to provide a digital certificate that identifies an authorized user and is signed by a trusted certificate authority;
a registration agent for providing a digital certificate authenticating the identity of a user of the endpoint device, the registration agent comprising:
a web interface for establishing a secure connection with the endpoint device and obtaining a digital certificate request from the endpoint device, over the secure connection, the digital certificate request comprising an indication of the identity of the user of the endpoint device and a public encryption key;
a trusted database storing an indication of a validation parameter associated with the user;
an authentication application for:
obtaining an indication of a validation parameter associated with the user from a trusted database;
providing the endpoint device with authentication instructions, the authentication instructions identifying verification data to be provided by the endpoint device;
receiving verification data from the endpoint device;
providing a signed digital certificate to the endpoint device over the secure connection only if the verification data correlates to the validation parameter, the signed digital certificate including the indication of the identity of the user of the endpoint device, the public encryption key, and a digital signature of the trusted certificate authority.

18. The system for providing network services to an endpoint device and over an open network of claim 17, wherein the open network is an Internet Protocol network and the secure connection is a secure socket layer connection established between an registration agent and the endpoint device.

19. The system for providing network services to an endpoint device and over an open network of claim 18, wherein:
validation parameter is a biometric validation parameter;
the trusted database stores, in association with the identity of the user, an indication that the validation parameter is a biometric validation parameter and a verification value identifying a biometric characteristic of the user; and
the authentication application (38) further provides for:
comparing the verification data and the verification value and determining if the verification data is within an acceptable deviation from the verification value to determine that the identity of the user of the endpoint device is authentic.

20. The system for providing network services to an endpoint device and over an open network of claim 18, wherein:
the validation parameter is a location validation parameter;
the trusted database stores a verification value identifying a location in association with the identity of the user and an indication of the validation parameter; and
the authentication application further provides for:
comparing the location provided by the endpoint device to the verification value stored in the trusted database and determining if the location provided by the endpoint device is within an acceptable deviation from the verification value to determine that the identity of the user of the endpoint device is authentic.
